(19) United States
(12) Patent Application Publication
(10) Pub. No.: US 2012/0024782 A1
(43) Pub. Date: Feb. 2, 2012

(54) METHOD AND APPARATUS FOR TREATING AN OIL SPILL

(76) Inventors: William E. Baird, Cohasset, MA (US); Patricia W. Baird, Cohasset, MA (US)

(21) Appl. No.: 13/110,785

(22) Filed: May 18, 2011

Related U.S. Application Data
(60) Provisional application No. 61/345,917, filed on May 18, 2010.
(60) Provisional application No. 61/362,909, filed on Jul. 9, 2010.
(60) Provisional application No. 61/371,062, filed on Aug. 5, 2010.

(51) Int. Cl. C02F 3/02; C02F 1/00

(52) U.S. Cl. 210/620; 210/696; 210/198.1

(57) ABSTRACT

A method for enhancing biodegradation of oil in water, the method comprising:
positioning a hollow structure in water, the hollow structure comprising an inlet and at least one outlet; and
introducing an oxygen-containing fluid into the inlet of the hollow structure so that the oxygen-containing fluid exits from the hollow structure and engages the oil, wherein the oxygen-containing fluid engages the oil with sufficient force so as to cause a mechanical dispersion of the oil.

### REFERENCE TO PENDING PRIOR PATENT APPLICATIONS

This patent application claims benefit of:

(i) pending prior U.S. Provisional Patent Application Ser. No. 61/345,917, filed May 18, 2010 by William E. Baird et al. for METHOD AND APPARATUS FOR TREATING AN OIL SPILL: BIOFENCE™ (Attorney's Docket No. BAIRD-1 PROV);

(ii) pending prior U.S. Provisional Patent Application Ser. No. 61/362,909, filed Jul. 9, 2010 by William E. Baird et al. for METHOD AND APPARATUS FOR TREATING AN OIL SPILL: BIOFENCE™ (Attorney's Docket No. BAIRD-4 PROV); and

(iii) pending prior U.S. Provisional Patent Application Ser. No. 61/371,062, filed Aug. 5, 2010 by William E. Baird et al. for METHOD AND APPARATUS FOR TREATING AN OIL SPILL: BIOFENCE™ (Attorney's Docket No. BAIRD-5 PROV).

The three (3) above-identified patent applications are hereby incorporated herein by reference.

### FIELD OF THE INVENTION

This invention relates to methods and apparatus for treating an oil spill in general, and more particularly to methods and apparatus for treating an oil spill in water.

### BACKGROUND OF THE INVENTION

An oil spill is a release of oil into the environment. The effect of an oil spill can be extremely detrimental to the environment, particularly when the size of the oil spill is substantial. Furthermore, when the oil spill occurs in water, the area of the oil spill can rapidly increase, exacerbating the environmental impact. Thus, where a large oil spill occurs in water (e.g., at an offshore oil rig or from a large oil tanker), the environmental impact can be enormous. The accident at the Deepwater Horizon oil rig in the Gulf of Mexico makes it clear that better ways of treating an oil spill, and containing the spread of an oil spill, particularly a large oil spill in water, are needed.

It is well known that there are naturally-occurring oil-consuming microorganisms which break down or remove oil from a body of water. The natural process of breaking down or removing oil from a body of water is commonly referred to as biodegradation. These microorganisms biodegrade oil both aerobically and anaerobically. Aerobic degradation of oil is many times more efficient (i.e., faster) than anaerobic degradation of oil. However, when an oil spill occurs, and a large quantity of oil is released into a body of water, the microorganisms that biodegrade oil aerobically use a significant amount of the oxygen present in the water to biodegrade or remove the oil from the body of water. The removal of significant amounts of oxygen from the water often results in the death of fish and other marine life. Furthermore, the depletion of significant amounts of oxygen from the water can inhibit further aerobic degradation of the oil by the microorganisms.

Thus, there is a need for a way to enhance the biodegradation of oil in a body of water while still maintaining a sufficient level of oxygen in the body of water to support fish and other marine life.

In addition to the foregoing, there is also a need for containing an oil spill in water in order to prevent the spread of the oil spill in water, or in order to guide the oil spill in a certain direction in water (e.g., away from a beach or marsh).

### SUMMARY OF THE INVENTION

The present invention comprises the provision and use of a novel method and apparatus for treating an oil spill in a body of water (e.g., ocean, lake, river, etc.) through the effective use of water aeration and microbes.

More particularly, the present invention is designed to add oxygen to the water, and also to add large quantities of microbes (which have been specifically grown to degrade or digest oil) to the water, so as to enhance biodegradation of oil in water and aid in the cleanup of the oil spill. This biodegradation of oil by microbes is sometimes referred to as bioremediation.

In one embodiment, oxygen is added to the water in an aggressive manner so as to help disperse the oil in the water and thereby facilitate the mechanical breakup of the oil spill. Furthermore, microbes are added to the water so as to help degrade the mechanically dispersed oil in water.

The present invention also provides a way to contain the oil spill in order to prevent the spread of the oil spill in water.

The present invention also provides a way to guide the oil spill in a certain direction in order to prevent the oil spill from reaching certain areas (e.g., the shoreline, harbor, etc.).

In one preferred form of the invention, there is provided a method for enhancing biodegradation of oil in water, the method comprising:

positioning a hollow structure in water, the hollow structure comprising an inlet and at least one outlet; and

introducing an oxygen-containing fluid into the inlet of the hollow structure so that the oxygen-containing fluid exits from the hollow structure and engages the oil, wherein the oxygen-containing fluid engages the oil with sufficient force so as to cause a mechanical dispersion of the oil.

In another preferred form of the invention, there is provided a system for enhancing biodegradation of oil in water, the system comprising:

a hollow structure for positioning in water, the hollow structure comprising an inlet and at least one outlet; and

apparatus for introducing an oxygen-containing fluid into the inlet of the hollow structure so that the oxygen-containing fluid exits from the hollow structure and engages the oil, wherein the oxygen-containing fluid engages the oil with sufficient force so as to cause a mechanical dispersion of the oil.

In another preferred form of the invention, there is provided a method for creating a barrier against an oil plume in a body of water, the method comprising:

positioning a hollow structure in water, the hollow structure comprising an inlet and at least one outlet; and

introducing a gas into the inlet of the hollow structure so that the gas exits from the hollow structure and forms a curtain of bubbles in the water such that the curtain of bubbles provides an effective barrier against the oil plume.

In another preferred form of the invention, there is provided a system for creating a barrier against an oil plume in a body of water, the system comprising:

a hollow structure for positioning in water, the hollow structure comprising an inlet and at least one outlet; and

apparatus for introducing a gas into the inlet of the hollow structure so that the gas exits from the hollow structure and forms a curtain of bubbles in the water such that the curtain of bubbles provides an effective barrier against the oil plume.

In another preferred form of the invention, there is provided a method for directing an oil plume in a body of water, the method comprising:

positioning a hollow structure in water, the hollow structure comprising an inlet and at least one outlet; and

introducing a gas into the inlet of the hollow structure so that the gas exits from the hollow structure and forms a curtain of bubbles in the water such that the curtain of bubbles directs the oil plume in a body of water.

In another preferred form of the invention, there is provided a method for dispersing oil in water, the method comprising:

positioning a hollow structure in water, the hollow structure comprising an inlet and at least one outlet; and

introducing a gas into the inlet of the hollow structure so that the gas exits from the hollow structure and engages the oil, wherein the gas engages the oil with sufficient force so as to cause a mechanical dispersion of the oil.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like parts and further wherein:

FIGS. 1-3 are schematic drawings illustrating a system for enhancing biodegradation of an oil spill in water;

FIG. 4 is a schematic drawing of the system of FIGS. 1-3 being used to contain an oil spill in water;

FIGS. 5 and 6 are schematic drawings illustrating a system for preventing an oil spill from reaching certain areas (e.g., a beach or marsh);

FIGS. 7-10 illustrate the system of FIGS. 5 and 6 being used to prevent an oil spill from reaching certain areas;

FIG. 11 is a schematic drawing of an anchor and cable which may be used to secure the system of the present invention in a body of water; and

FIGS. 12-17 are schematic drawings of an anchor which may be used to secure the system of the present invention in a body of water.

### DETAILED DESCRIPTION OF THE PRESENT INVENTION

### System for Enhancing Biodegradation of Oil in Water

The present invention comprises the provision and use of a novel method and apparatus for treating an oil spill in a body of water (e.g., ocean, lake, river, etc.) through the effective use of water aeration and microbes.

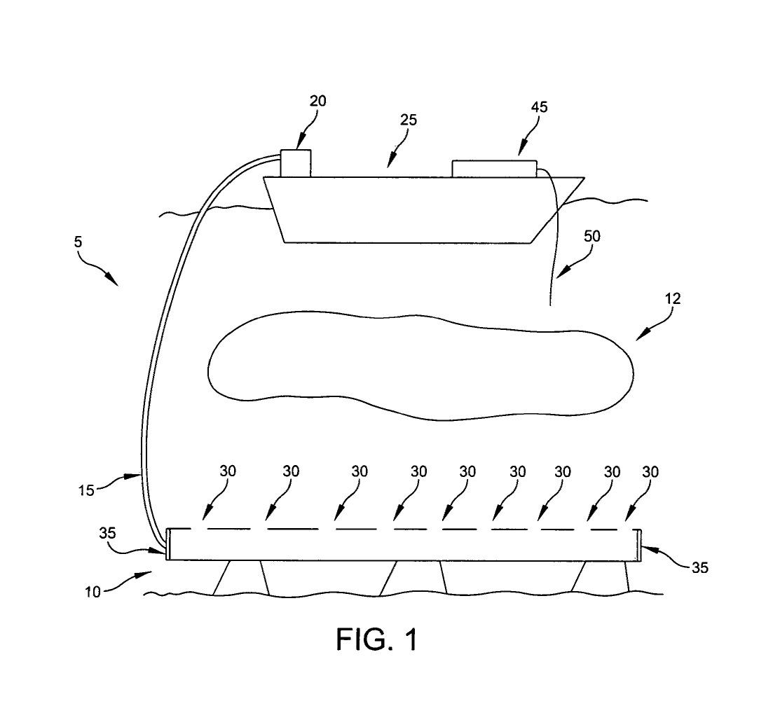

In accordance with the present invention, and looking now at FIGS. 1-3 there is shown a novel system for delivering oxygen to a body of water so as to help disperse the oil in the water and thereby facilitate the mechanical breakup of the oil spill. In this respect it should be appreciated that mechanically breaking up the oil spill facilitates the bioremediation and therefore the destruction of the oil. This is because the more the oil spill is broken down into smaller size, the more the surface area of the oil and, therefore, the more the area for the microbes to penetrate and destroy the oil.

System 5 comprises a pipe 10 preferably positioned along, or just above, the floor of a body of water and directly below an oil plume 12, and a high pressure hose 15 for passing high pressure air (i.e., atmospheric air) into pipe 10. Pipe 10 preferably has a straight elongated configuration, although it could also have other configurations if desired, e.g., arcuate (curved) or some other more complex shape. High pressure hose 15 is connected to an air source (e.g., air compressor 20) at one end of the hose and to pipe 10 at the other end of the hose. Air compressor 20 may be located on a vessel (e.g., barge or ship 25) or on land. Alternatively, if desired, high pressure hose 15 may be configured to pass another oxygen-rich fluid (e.g., oxygen gas) into pipe 10. However, for clarity of description, the present invention will hereinafter generally be discussed in the context of passing high pressure air into pipe 10.

Pipe 10 comprises perforations 30 along the length of the pipe. In one form of the invention, perforations 30 comprise a plurality of round holes.

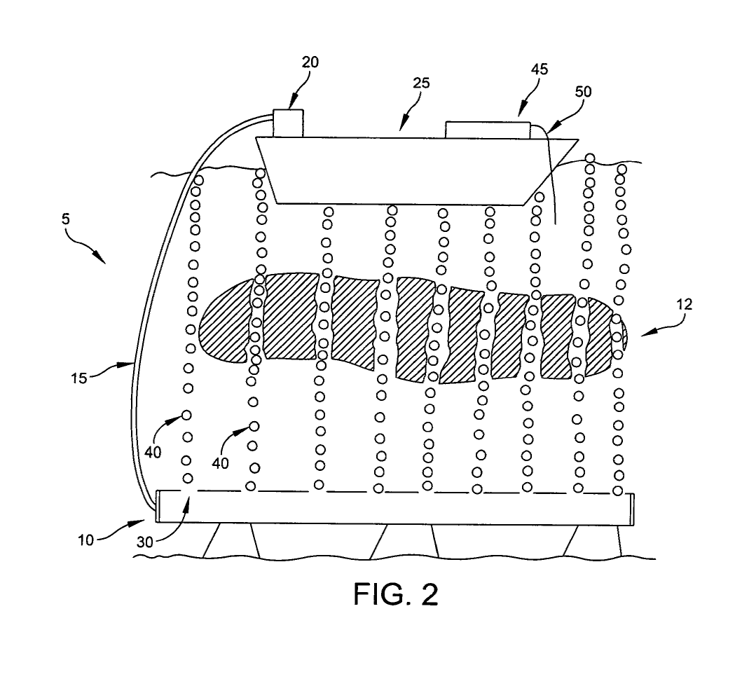

In another form of the invention, perforations 30 comprise a plurality of longitudinally-extending slits. In still another form of the invention, perforations 30 comprise a single elongated slit. Preferably, at least the end of pipe 10 which is opposite to the end of the pipe connected to high pressure hose 15 is sealed (e.g., with a cap 35) so as to force the air passing into pipe 10 to exit through perforations 30 extending along the length of the pipe. The air bubbles 40 produced by the pressurized air exiting perforations 30 effectively form columns of air (FIG. 2) that pass through oil plume 12 as air bubbles 40 rise to the surface of the water.

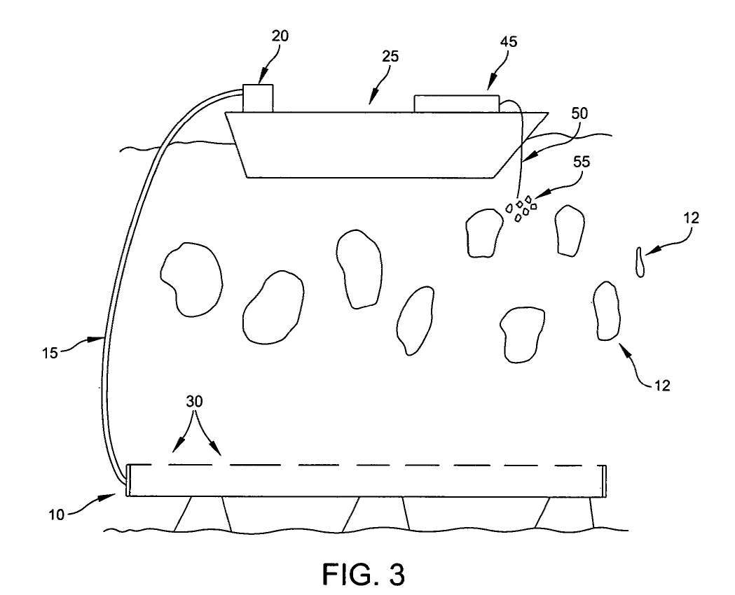

As shown in FIG. 2, as the highly pressurized air bubbles pass through oil plume 12, the oil plume is mechanically broken up and dispersed throughout the body of water (FIG. 3). In this respect it will be appreciated that it is important that the air be added to the water in an aggressive manner so as to facilitate the mechanical disruption of the oil plume, and this can be achieved by coordinating a number of different factors, e.g., the pressure with which the air is supplied to pipe 10, the size of the perforations 30, the velocity of the air bubbles 40 when they engage oil plume 12, etc. The adjustment of these various factors will be apparent to those skilled in the art in view of the present disclosure.

In the case of crude oil, tar balls may be trapped in the vertical flow of air and forced to the surface of the body of water, whereby the tar balls may be collected and removed from the water.

Thus, it can be seen that the present invention provides a system for delivering oxygen to a body of water wherein the oxygen is delivered to the body of water so that air bubbles 40 engage oil plume 12 with a sufficient amount of force to mechanically break up an oil plume. By delivering oxygen to a body of water in this manner, not only is the surface area of the oil greatly increased (and hence the surface area of the oil available for microbial biodegradation greatly increased), but the level of oxygen available for aerobic biodegradation of the oil is also increased, which in turn enables an increased degradation of the oil spill. In addition, by delivering oxygen to the water in this manner, a sufficient level of oxygen is maintained in the body of water to support fish and other marine life.

In one embodiment of the present invention, system 5 further comprises a microbe mixer 45 and a microbe hose 50 for delivering microbes 55 (FIG. 3) to the water so as to further enhance the biodegradation of the oil in water. Preferably, microbes 55 have been specifically grown to degrade or digest oil in a body of water. By way of example but not limitation, the microbes supplied through microbe hose 50 are contained in the microbial product supplied by MicroSorb Environmental Products, Inc. of Norwell, Mass., which contains billions of microbes per gram or liter, cultivated in a “fermenter” on crude oil and sea water so as to create enormous numbers of the desired microbes per gram or liter.

Alternatively, microbes 55 may be delivered to the water by encasing the microbes in a water soluble package which is introduced into the water, or by otherwise delivering microbes 55 to the water. By supplementing the naturally-occurring microbes indigenous to the water with specially grown microbes, the microbial activity, and thus biodegradation of oil, can be significantly enhanced.

In addition to the foregoing, nutrients (or other bioremediation-facilitating products) such as nitrogen and phosphorus may be delivered through microbe hose 50 or by other means (e.g., a water soluble package) in order to further enhance bioremediation.

### System for Containing an Oil Spill in Water

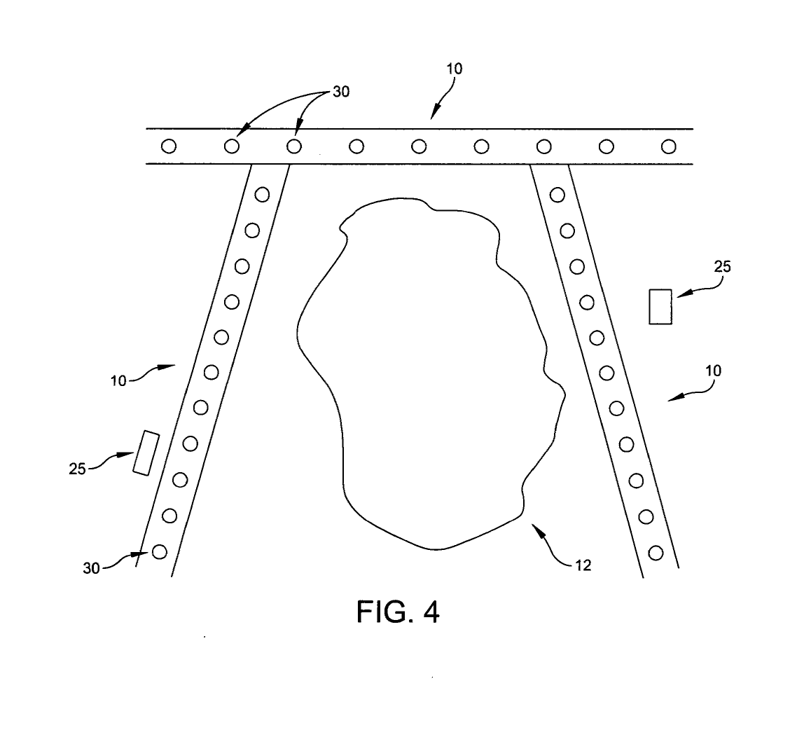

In another embodiment of the present invention, and looking now at FIG. 4, one or more pipes 10 (preferably having a plurality of closely spaced perforations 30) may be placed in the water in a V-shaped configuration or a modified V-shaped configuration. The closely spaced air columns produced by the pressurized air exiting perforations 30 in pipe 10 and rising to the surface of the water effectively form a wall of closely spaced air bubbles (i.e., an “air curtain”) in the path of oil plume 12. By ensuring that the air curtain is a relatively turbulent mass of air and water, the air curtain can effectively act as a barrier to the oil plume. The air curtains formed by each of the pipes, and the arrangement of the pipes in a V-shaped configuration or a modified V-shaped configuration, have the effect of containing the spread of oil plume 12. In this respect it should be appreciated that these air curtains will provide a barrier to oil plume 12 regardless of whether oil plume 12 is at the surface of the water or below the surface of the water. In addition, since the air curtain contains a sizable amount of oxygen, the air curtain also has the effect of simultaneously introducing oxygen to the water so as to enhance aerobic digestion of the oil by microbes.

Significantly, if desired, bubbles 40 may be used solely to constrain movement of oil plume 12 in the water and not to supplement aerobic digestion of the oil. In this case, the high pressure fluid being introduced into pipe 10 need not necessarily contain oxygen (although atmospheric air is generally preferred due to its ready availability).

### System for Guiding the Oil Spill in Order To Prevent Oil from Reaching Certain Areas Or for Directing the Oil Spill to a Specific Area to Facilitate Physical Removal

In some circumstances, it may be desirable to position the system of the present invention at the entrance to a bay, harbor or bayou, at the mouth of a river or canal, or along a shoreline, in order to prevent an oil plume from entering into these areas or from reaching the shoreline. In other circumstances, it may be useful to use the system to direct the oil spill to a specific area to facilitate physical removal of the oil spill.

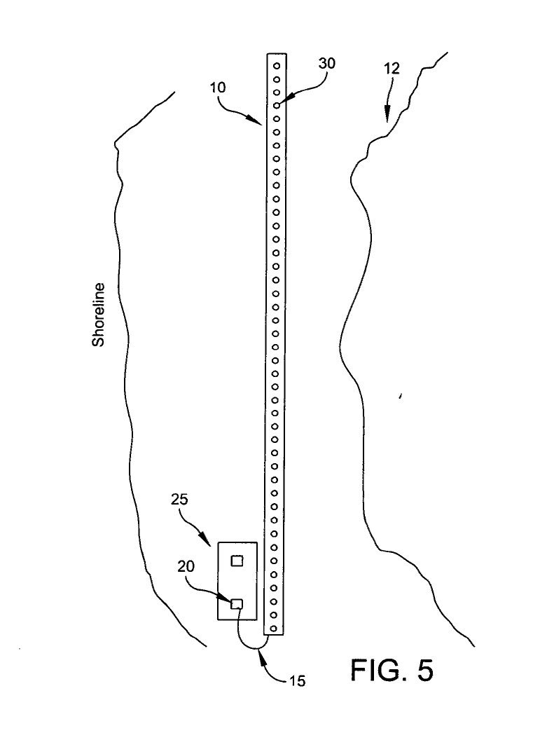

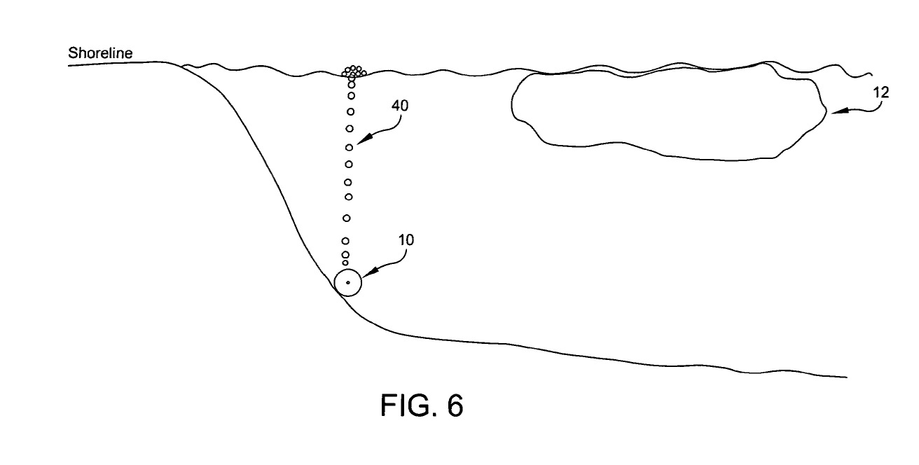

To this end, and looking now at FIGS. 5 and 6, at least one pipe 10, with perforations 30, is positioned in the pathway of an oil spill 12, preferably along (or just above) the floor of a body of water. If desired, pipe 10 (or pipes 10) may be placed in a V-shaped configuration or a modified V-shaped configuration. Pipe 10 is connected to a high pressure hose 15 for passing high pressure air (or another appropriate fluid) received from a source (e.g., air compressor 20) into pipe 10. The source (e.g., air compressor 20) may be located on a vessel (e.g., barge or ship 25) or on land.

As stated above, pipe 10 is preferably capped at its free end (if high pressure hose 15 is connected to one end of pipe 10), or capped at both ends (if high pressure hose 15 is connected intermediate the length of pipe 10) so as to force the air passing into the pipe to exit through the perforations extending along the length of the pipe. The air bubbles 40 produced by the pressurized air exiting perforations 30 and rising to the surface of the water effectively form an air curtain in the path of oil plume 12. Again, this air curtain is created so that it has sufficient turbulence to form an effective barrier for the oil plume. Since the pipe is located in the pathway of oil plume 12, it will have the effect of creating a barrier in the water, thus preventing the oil plume from entering into a bay or harbor or river or canal, or from reaching shoreline, etc.

In another embodiment of the present invention, pipe 10 (with perforations 30) may be attached to the side of a boat or may be towed behind a boat, preferably submerged in the water, and the pressurized air may be passed through pipe 10 and out of perforations 30 so as to prevent oil plume 12 from reaching sensitive areas (e.g., a shoreline or marsh).

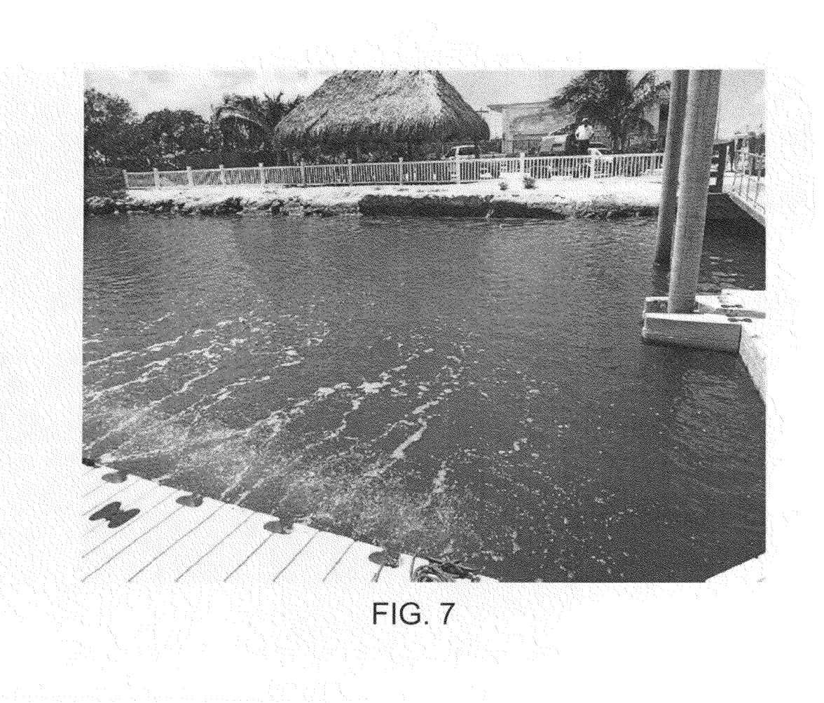

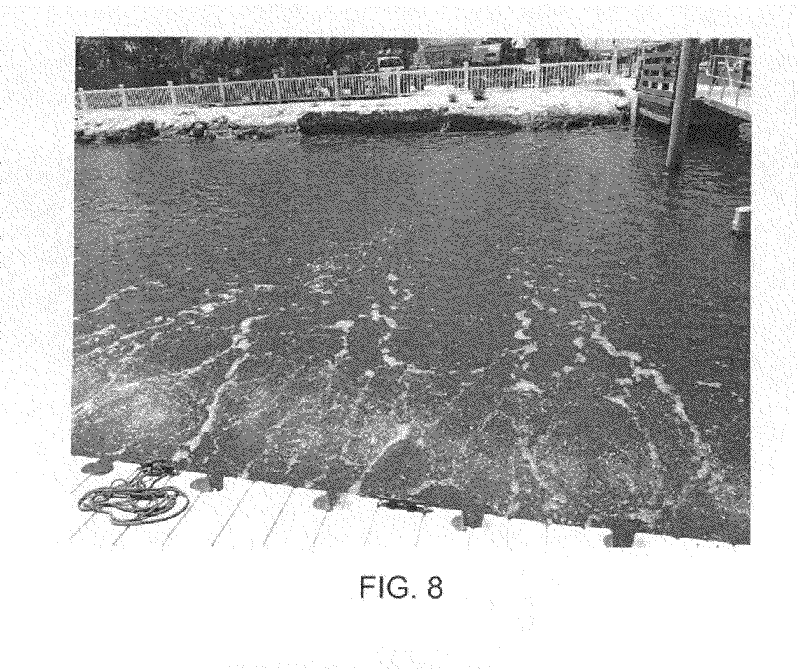

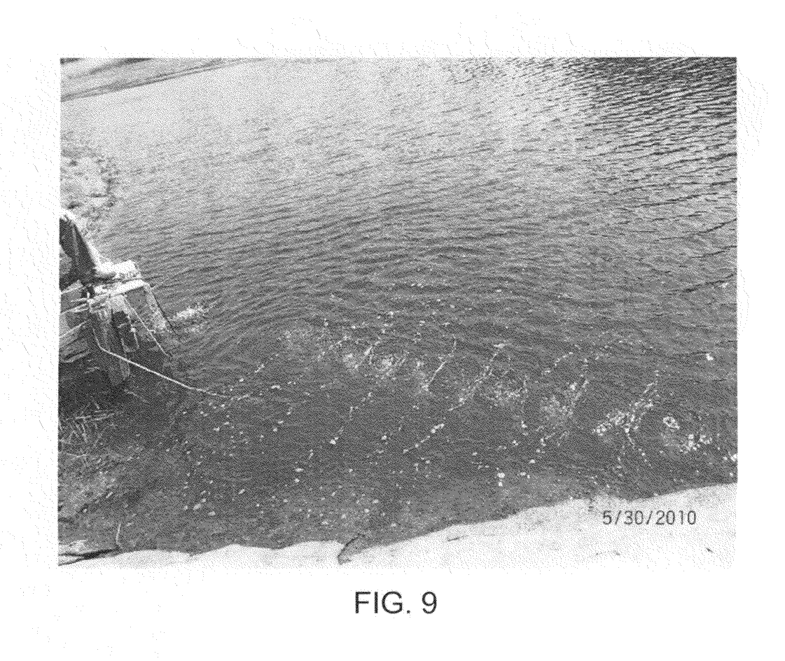

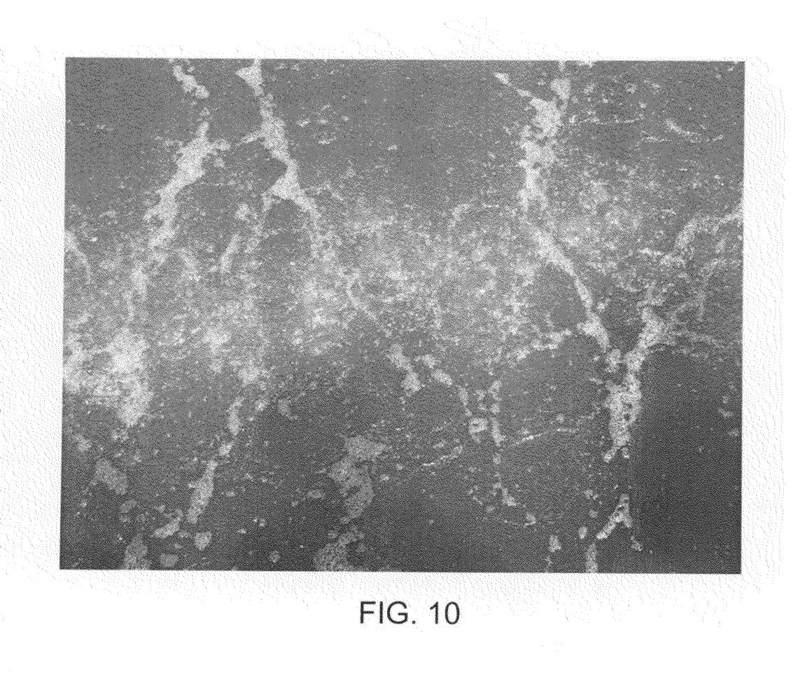

In yet another embodiment of the present invention, and looking now at FIGS. 7-10, pipe 10 (with perforations 30) may be attached to the side of a dock and the pressurized air may be passed through pipe 10 and out of perforations 30 so as to direct the flow of air away from the dock, thereby preventing oil plume 12 from reaching land.

Additionally, as noted above, system 5 may be used to direct the oil spill to a specific area to facilitate physical removal of the oil spill, e.g, with surface skimmers.

Furthermore, system 5 may be used to mobilize sub-surface portions of an oil plume (such as floating tar balls or heavy oil) for surface recovery. By way of example but not limitation, some of the heavy oil that is sitting on the floor of an ocean oil spill could be mobilized by the turbulent air bubbles created by the system and rising in the water, so that the oil can be recovered on the surface.

It is important to note that perforations 30 in pipe 10 may be formed in the top of the pipe, in the side of the pipe and/or in the bottom of the pipe, and this may depend on where pipe 10 is positioned in the body of water. By way of example but not limitation, if pipe 10 is positioned on the floor of the ocean, perforations 30 could be formed in the top of pipe 10 so that air bubbles 40 rise to the surface of the water and effectively form an air curtain in the path of an oil spill. Alternatively, if pipe 10 is floating on a body of water, or attached to a boat or a dock, perforations 30 could be formed in the side of pipe 10 so that air bubbles 40 are directed through the body of water, thus forming a turbulent air bubble barrier to the oil spill.

### General Construction of the Present Invention

Pipe 10 may be made of steel, heavy hose, polyvinyl chloride (PVC) or any other material consistent with the present invention, and is preferably two inches to four inches in diameter, although it may also be of other sizes (e.g., 0.50 inch to 20+ inches in diameter). Perforations 10 are preferably 0.05 inch to 1.0 inch in diameter, although they may also be of any other size consistent with the present invention.

As stated above, pipe 10 may be anchored on the floor, or otherwise suspended a few feet above the floor, of the body of water. It is important that pipe 10 be secured in the body of water so that pipe 10 does not unintentionally move in the water, e.g., under the influence of a current or tide, etc. This is particularly important where there is a strong current, such as may exist at the entrance to harbors, bayous, rivers, bays, etc.

In one embodiment of the present invention, and looking now at FIG. 11, pipe 10 may be anchored (with or without a flotation device 58) to the ocean floor through the use of an anchor 60 secured to pipe 10 by a cable 65. In this embodiment, the length of cable 65 is selected so that pipe 10 is anchored in the body of water at the desired depth. By way of example but not limitation, when pipe 10 is to be secured a few feet off of the floor of a body of water, the length of cable 65 used to attach pipe 10 to anchor 60 would also be a few feet long.

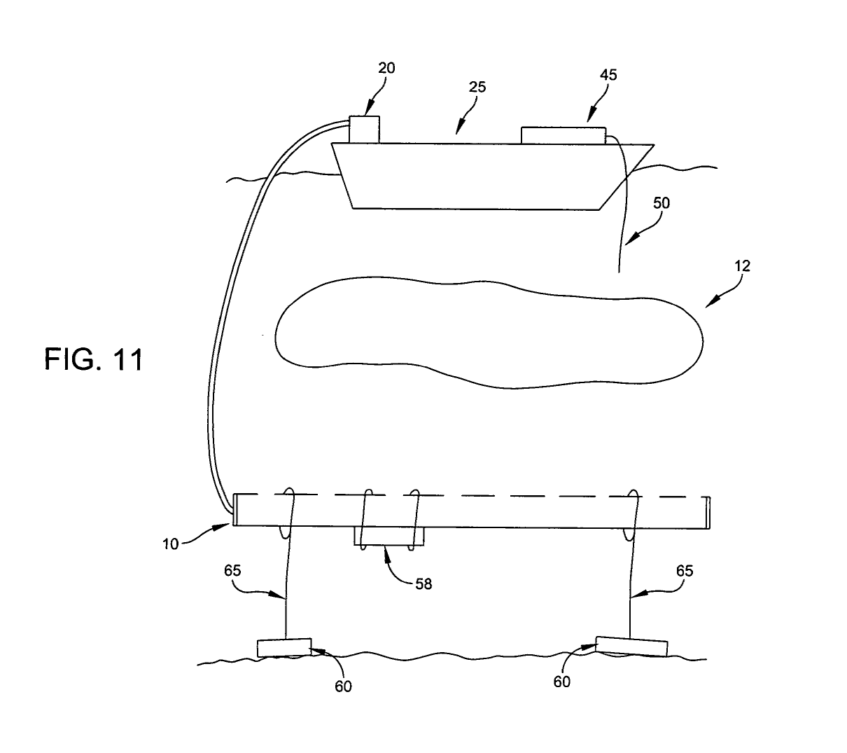

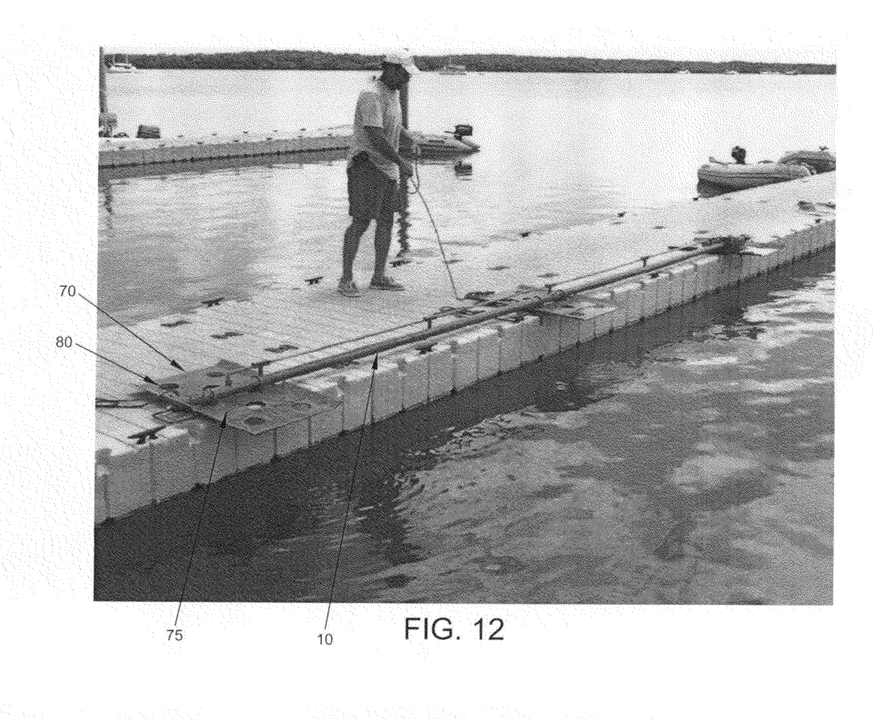

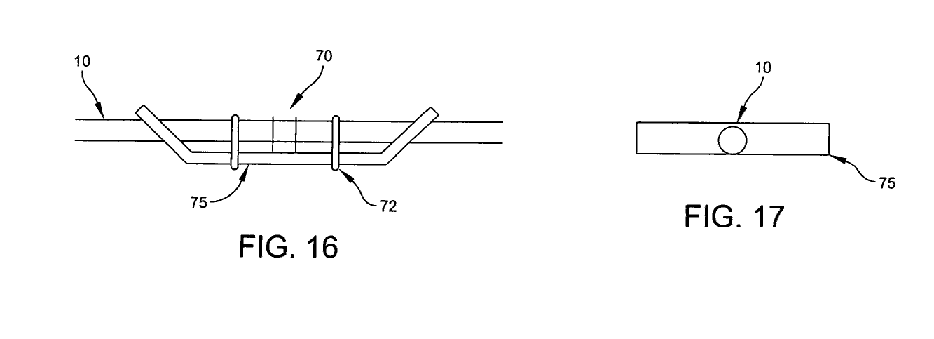

In another embodiment, and looking now at FIGS. 12-17, pipe 10 may be positioned and secured to the floor of a body of water through the use of an anchor 70. Pipe 10 may be attached to anchor 70 by U-bolts 72 or welding.

In one embodiment, anchor 70 comprises a steel skid plate 75 having an appropriate thickness (e.g., between approximately 1/16 of an inch and ⅜ of an inch, or some other appropriate thickness (which may be much thicker in high current areas or where the size, and hence the buoyancy, of pipe 10 is high) and having holes 80 formed therein. The unit (e.g., pipe 10 and attached anchor 70) is positioned along the floor of a body of water, and if the unit should unintentionally shift with the water current or tide, holes 80 fill with sand and further anchor the unit to the floor of the body of water.

In addition to using anchor 70 to secure pipe 10 in a body of water, anchor 70 may also be used prevent two sections of a pipe from being pulled apart. More particularly, anchor 70 may be attached to pipe 10 at each point where pipe 10 is connected (or coupled) to another pipe 10 in order to prevent the two sections of the pipe from being pulled apart.

### Further Constructions

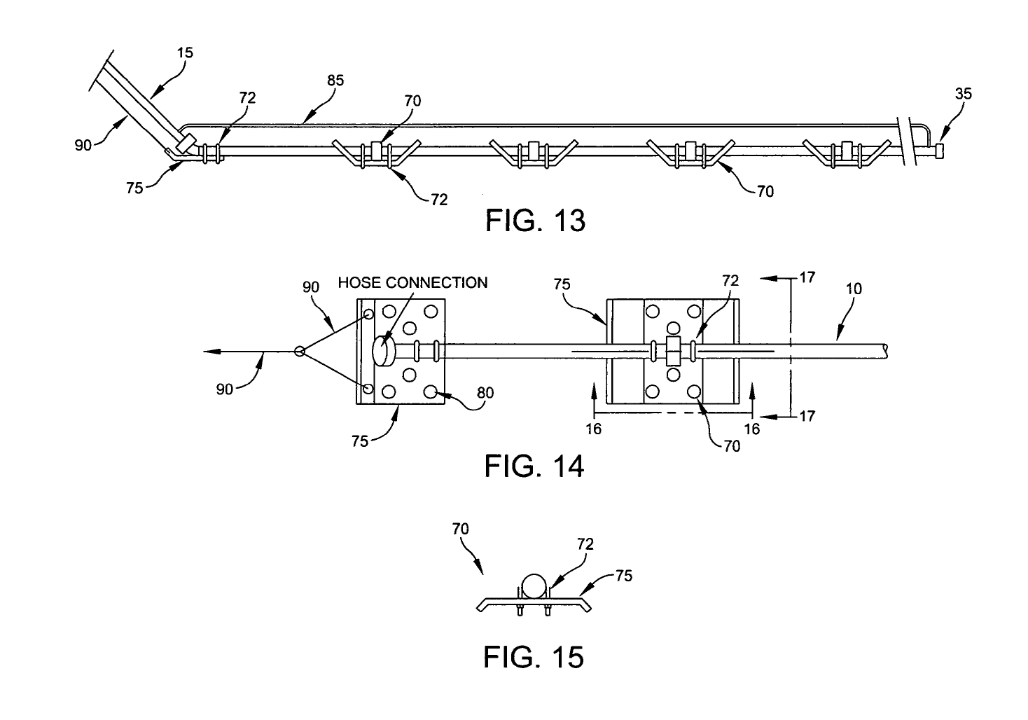

In another embodiment of the present invention, pipe 10 may also be provided with an equalization pipe so that air may be delivered into and through pipe 10 at both ends of the pipe. More particularly, and looking now at FIG. 13, a small diameter equalization pipe 85 is attached to pipe 10 for equalizing the air pressure so that air pressure may be delivered into and through pipe 10 at both ends of the pipe.

In still another embodiment of the present invention, system 5 may also comprise a chain or wire rope 90 attached as a yoke to anchor 70, so that system 5 can be pulled into place or moved through the body of water by pulling chain or wire rope 90 attached to anchor 70.

In another embodiment of the present invention, a wire cable may be extended along the length of pipe 10 and attached to at least one of pipe 10 and anchor 70. Hoses of various lengths may be attached to the cable or the pipe. The hoses deliver microbes or nutrients to the water to help degrade the oil.

### Additional Concepts

It should also be appreciated that the air/oxygen emerging from pipe 10 can be directed by tide and/or wind to certain sensitive areas that require bioremediation. By way of example but not limitation, pipe 10 can be positioned off shore and tide and/or wind can be used to deliver the air/oxygen toward shore.

Furthermore, oyster beds and clam beds can be bioremediated by using system 5 to deliver air/oxygen and microbes to the beds so as to protect these important resources. By way of example but not limitation, system 5 may be placed on both sides of an oyster bed to continuously supply oxygen (and preferably bioremediation microbes as well) to the oyster bed and thereby facilitate a faster cleanup of oil in the oyster bed.

### Modifications of the Preferred Embodiments

It should be understood that many additional changes in the details, materials, steps and arrangements of parts, which have been herein described and illustrated in order to explain the nature of the present invention, may be made by those skilled in the art while still remaining within the principles and scope of the invention.

What is claimed is:

1. A method for enhancing biodegradation of oil in water, the method comprising:
positioning a hollow structure in water, the hollow structure comprising an inlet and at least one outlet; and
introducing an oxygen-containing fluid into the inlet of the hollow structure so that the oxygen-containing fluid exits from the hollow structure and engages the oil, wherein the oxygen-containing fluid engages the oil with sufficient force so as to cause a mechanical dispersion of the oil.

2. A method according to claim 1 wherein the oxygen-containing fluid is introduced into the hollow structure under pressure.

3. A method according to claim 2 wherein the oxygen-containing fluid comprises air.

4. A method according to claim 3 wherein the at least one outlet is sized so that when the pressurized air exits the hollow structure, it forms bubbles large enough to mechanically disperse the oil.

5. A method according to claim 4 wherein the hollow structure comprises a plurality of outlets.

6. A method according to claim 4 wherein the at least one outlet comprises a slot.

7. A method according to claim 5 wherein the plurality of outlets are configured so that the bubbles form an air curtain.

8. A method according to claim 7 wherein the air curtain has a linear configuration.

9. A method according to claim 7 wherein the air curtain has an arcuate configuration.

10. A method according to claim 7 wherein the hollow structure comprises a plurality of hollow segments, each of the hollow segments comprising a plurality of outlets, and further wherein at least some of the plurality of hollow segments are arranged in one of a V-shaped configuration and a modified V-shaped configuration.

11. A method according to claim 1 also comprising introducing microorganisms to aerobically biodegrade the oil.

12. A method according to claim 1 wherein the oxygen-containing fluid is introduced through a hose connected to the inlet of the hollow structure.

13. A method according to claim 11 wherein the microorganisms are introduced through a hose.

14. A system for enhancing biodegradation of oil in water, the system comprising:
a hollow structure for positioning in water, the hollow structure comprising an inlet and at least one outlet; and
apparatus for introducing an oxygen-containing fluid into the inlet of the hollow structure so that the oxygen-containing fluid exits from the hollow structure and engages the oil, wherein the oxygen-containing fluid engages the oil with sufficient force so as to cause a mechanical dispersion of the oil.

15. A method for creating a barrier against an oil plume in a body of water, the method comprising:
positioning a hollow structure in water, the hollow structure comprising an inlet and at least one outlet; and
introducing a gas into the inlet of the hollow structure so that the gas exits from the hollow structure and forms a curtain of bubbles in the water such that the curtain of bubbles provides an effective barrier against the oil plume.

16. A method according to claim 15 wherein the gas-containing fluid comprises air.

17. A method according to claim 16 wherein the air is introduced into the hollow structure under pressure.

18. A method according to claim 15 wherein the hollow structure comprises a plurality of outlets which are arranged in a row.

19. A method according to claim 15 wherein the at least one outlet is in the form of a slot.

20. A method according to claim 15 wherein the hollow structure comprises a plurality of hollow segments, each of the hollow segments comprising a plurality of outlets, and further wherein at least some of the plurality of hollow segments are arranged in one of a V-shaped configuration and a modified V-shaped configuration.

21. A system for creating a barrier against an oil plume in a body of water, the system comprising:
a hollow structure for positioning in water, the hollow structure comprising an inlet and at least one outlet; and
apparatus for introducing a gas into the inlet of the hollow structure so that the gas exits from the hollow structure and forms a curtain of bubbles in the water such that the curtain of bubbles provides an effective barrier against the oil plume.

22. A method for directing an oil plume in a body of water, the method comprising:
positioning a hollow structure in water, the hollow structure comprising an inlet and at least one outlet; and
introducing a gas into the inlet of the hollow structure so that the gas exits from the hollow structure and forms a curtain of bubbles in the water such that the curtain of bubbles directs the oil plume in a body of water.

23. A method for dispersing oil in water, the method comprising:
positioning a hollow structure in water, the hollow structure comprising an inlet and at least one outlet; and
introducing a gas into the inlet of the hollow structure so that the gas exits from the hollow structure and engages the oil, wherein the gas engages the oil with sufficient force so as to cause a mechanical dispersion of the oil.
